(19) United States
(12) Patent Application Publication
(10) Pub. No.: US 2008/0215168 A1
(43) Pub. Date: Sep. 4, 2008

(54) TRANSACTION AND ADMINISTRATION MANAGEMENT SYSTEM, SUCH AS FOR FANTASY SPORTS

(76) Inventor: Paul W. Charchian, Plymouth, MN (US)

Correspondence Address: BOSWELL INTELLECTUAL PROPERTY LAW PLLC, PO BOX 1950, SEATTLE, WA, 98111, US

(21) Appl. No.: 12/038,427

(22) Filed: Feb. 27, 2008

Related U.S. Application Data
(60) Provisional application No. 60/904,163, filed on Mar. 1, 2007.

(51) Int. Cl. G06F 19/00; A63F 9/24

(52) U.S. Cl. 700/91; 463/25; 463/42

(57) ABSTRACT

A transaction system is described herein for managing league decisions and the collection and payment of assets related to fantasy sports transactions. The transaction system may be accessible to transaction participants, such as league commissioners and team owners, through a hosted service on the Internet that provides a user interface for viewing transaction information and an authorization method determined by the participants for completing transactions. In this way, the transaction system provides a structured environment in which fantasy sports transactions are completed. The transaction system stores the assets associated with the transaction in a league account until conditions are satisfied for the assets to be distributed at the end of the season to owners' accounts based on an agreed-upon process. Payments can be issued from each owner's account to the owner. Thus, the transaction system allows transactions to be completed even in conditions where the commissioner is unavailable or team owners do not unanimously agree on the disposition of the transaction.

### CROSS-REFERENCE TO RELATED APPLICATIONS

The present application claims the benefit of U.S. Provisional Application No. 60/904,163 (Attorney Docket No. 667078001 US), entitled “LeagueSafe,” and filed on Mar. 1, 2007, which is hereby incorporated by reference.

### BACKGROUND

A fantasy sport (also known as rotisserie, roto, or owner simulation) is a game where fantasy owners build teams that compete against the teams of other fantasy owners based on the statistics generated by individual players or teams of a real professional sport. Fantasy team owners can trade, cut, and sign players just like a real sports owner. One common variant converts statistical performance into points that are compiled and totaled according to a roster of a fantasy team's players. These point systems are typically simple enough to be manually calculated by a “league commissioner” that oversees a group of fantasy teams. Variants that are more complex use computer modeling of actual games based on statistical input generated by professional sports.

A seminal moment for the growth of fantasy sports was the rise of the Internet in the mid-1990s. The new technology lowered the barrier to entry to the hobby as owners could quickly compile statistics online and news and information became readily available. While several fantasy businesses had migrated to the Internet in the mid-1990s, the watershed era for online fantasy sports was in 1997 when two web sites made their debut and forever changed the fantasy sports industry: Commissioner.com and RotoNews.com. RotoNews.com launched the Web's first free commissioner service in 1998, quickly becoming the largest league management service. It was not long before the larger media players got involved. Yahoo.com added fantasy sports in 1999 and offered most of its games free of charge. A trade group for the industry, the Fantasy Sports Trade Association, was formed in 1998.

The Fantasy Sports Trade Association estimates that 19.4 million people aged 12 and above in the United States and Canada play fantasy sports and 34.5 million people have played fantasy sports at some point. A 2006 study showed 22 percent of U.S. adult males 18 to 49 years old, with Internet access, play fantasy sports. Fantasy sports are estimated to have a $3-$4 billion annual economic impact across the sports industry. Fantasy sports are also popular throughout the world with leagues for football (known as soccer in the United States), cricket, and other non-U.S. based sports.

Although several services exist for managing league membership and tracking statistics, the process of managing decisions within the league and for collecting and distributing payments is still a largely manual process. In a typical fantasy league, a commissioner collects an entry fee from each fantasy team owner at the beginning of the season. The team owners may send the commissioner a check or make some other kind of traditional payment, which the commissioner typically places into his/her personal bank account. Prior to the start of the season, league owners agree upon the payout criteria for the league. At the end of the season, the commissioner and/or owners recognize winning teams and the commissioner generates final payments to the winning team owners.

While this manual process often goes smoothly, many areas may cause problems. For example, team owners may not agree on the rules for payments. Alternatively, team owners may agree on the rules but not their application to determine which owner is due a payment. At the beginning of the season, owners may be slow to submit their entry fee, causing an administrative burden to the commissioner to track them down and remind them to submit their payments. In addition, because of the passage of time from when the commissioner collects entry fees to the end of season payment, many things may happen. The league commissioner may become ill, may become disinterested in managing the league, or may simply be dishonest and want to keep the money. A spouse could inadvertently or intentionally write checks against the league balance while funds reside in the commissioner's checking account. For whatever reason, the commissioner may disappear with the money from entry fees. Even when the commissioner is available and has correctly managed the money, disputes may arise, and there is no well-defined process for resolving them. Using current systems, there is virtually no financial transparency between owners and the league commissioner.

### BRIEF DESCRIPTION OF THE DRAWINGS

FIG. 1 is a block diagram that illustrates components of a transaction system in one embodiment.

FIG. 2 is a display page that illustrates a user interface for the creation of a poll for selecting an authorization method in one embodiment.

FIG. 3 is a flow diagram that illustrates the processing of an authorization method component to ratify a proposal using a majority authorization method in one embodiment.

FIG. 4 is a display page that illustrates a user interface displayed by a user interface component for receiving votes in one embodiment.

FIG. 5 is a display page that illustrates a user interface displayed by the user interface component for displaying a summary of polls in one embodiment.

FIG. 6 is a display page that illustrates the creation of a poll for a final payout of the season in one embodiment.

### DETAILED DESCRIPTION

### Overview

A transaction system is described herein for managing league collection and payment of assets related to fantasy sports transactions. The transaction system may be accessible to transaction participants, such as league commissioners and team owners, through a hosted service on the Internet (or through other network connections) that provides an interface (e.g., a web page) for viewing transaction information. The league commissioner generally starts the process by logging into the hosted service and creating a league. The transaction system receives league information from the league commissioner that may include a league name, a league type (e.g., football, baseball, and so on), an identification of one or more team owners that belong to the league, contact information of the one or more team owners, an entry fee for joining the league, and an authorization method that describes a process having one or more conditions for ratifying decisions related to the league. After the league commissioner creates the league, the transaction system automatically contacts the team owners using the contact information provided by the league commissioner to invite the team owners to join the league and pay the entry fee. For example, the transaction system may send an email message to each of the team owners that contains a link to a web page provided by the transaction system for specifying team information.

Each team owner accesses the transaction system to provide information about his team. For example, the information may include a team name, contact address, messages to other owners, and other forms of league administration. The team owner may also provide a payment of assets based on the entry fee. For example, the team owner may make a monetary payment by providing credit card information or information for making a bank transfer (e.g., an Automated Clearing House (ACH) payment). The transaction system stores the assets from the received payments from team owners into a bank account controlled by the operator of the transaction system and/or its partners. Because the bank holds the assets, team owners are no longer subject to a commissioner that disappears or absconds with the funds from team owners.

The transaction system determines when an event has occurred for which a payment of assets may be due, typically when the season has ended. When such an event occurs, the transaction system invokes the process described by the authorization method to determine which owners should be paid and how much. When the conditions of the authorization method are satisfied, the transaction system distributes the payment based on the authorization method from the assets stored under the control of the transaction system. For example, if a majority of the team owners vote affirmatively that a payment is due, then the transaction system will transfer funds from the league's balance to the owner's balance. Whenever an owner has a positive balance, the owner may withdraw funds.

In this way, the transaction system provides a structured environment in which fantasy sports transactions are completed. The transaction system stores the assets associated with the transaction until conditions are satisfied for the assets to be distributed based upon an agreed-upon process (i.e., the authorization method). The authorization method allows transaction participants to agree in advance about how payments will be made. Thus, the transaction system allows transactions to be completed even in conditions where the commissioner is unavailable or team owners do not unanimously agree on the disposition of the transaction.

### Suitable System

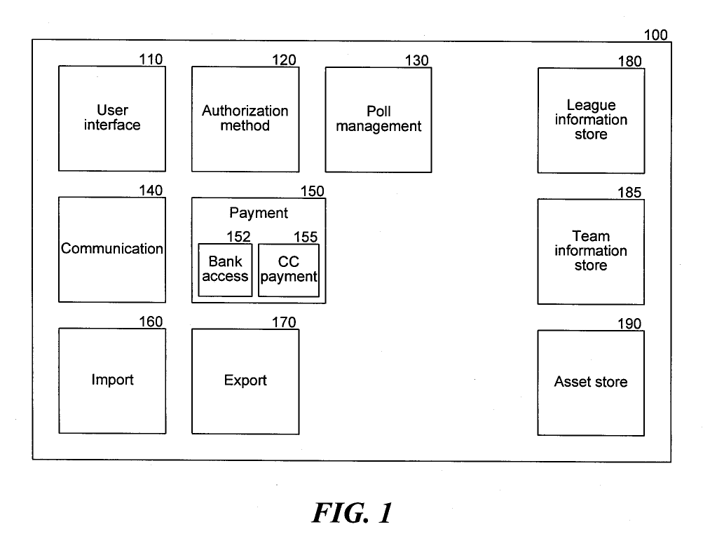

FIG. 1 is a block diagram that illustrates components of the transaction system in one embodiment. The transaction system 100 includes a user interface component 110, an authorization method component 120, a poll management component 130, a communication component 140, a payment component 150, an import component 160, an export component 170, a league information store 180, a team information store 185, and an asset store 190. The user interface component 110 displays information to transaction participants (e.g., the commissioner and team owners), including a home page for each league and team, balance and transaction information about league and team accounts, display pages for creating and viewing polls, and so forth.

The authorization method component 120 stores the currently selected authorization method and ensures that proposals (e.g., polls and payments) are carried out in accordance with the selected authorization method. For example, if the authorization method specifies majority voting, then the authorization method component 120 ensures that a majority of affirmative votes are received before a proposal is allowed to pass. The poll management component 130 manages the creation of polls and receives votes from each voting participant. The poll management component 130 may also send reminders at appropriate times during the lifetime of a poll and terminate the poll after a specified time.

The communication component 140 sends communications to transaction participants, such as via email, message board, or other forms of communication. For example, the communications may include reminder emails, requests to vote on polls, confirmations, and so forth. The payment component 150 processes payments including deposits and withdrawals to and from league and team accounts. The payment component 150 may comprise a bank access component 152 and a credit card payment component 155 for accessing bank and credit card accounts, respectively.

The import component 160 imports information that is useful to the transaction system, such as league information and player information from other systems, statistics, and so on. The export component 170 exports information from the transaction system. For example, the transaction system may provide an externally accessible application programming interface (API) for accessing information stored by the transaction system. The export component 170 may allow transaction participants or third parties to extend the transaction system with additional functionality.

The league information store 180 stores information about the league, such as the league name and league account balance. The team information store 185 stores information about the team, such as the team name, team owner, and team account balance. The asset store 190 stores assets, such as payments made by commissioners and team owners, and may interact with the payment component 150 to store the assets in a bank account or other location. The league information store 180, team information store 185, and asset store 190 may be stored separately or in a common database.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Authorization Method

In some embodiments, the transaction system allows many different types of authorization methods for making decisions related to the league. On one hand, the transaction participants may select an authorization method that gives the commissioner exclusive decision-making authority. On the other hand, the transaction participants may select an authorization method that calls for unanimous approval of the team owners to ratify a decision. More typically, transaction participants select a majority-based authorization method in which a majority vote of team owners is sufficient to ratify a decision. There may be other types of authorization methods that transaction participants or the league commissioner may select when setting up the league. For example, the transaction system may track a reputation score for each transaction participant based on feedback from past transactions or other information and voting may be based on the reputation of the participant. In general, the authorization method has the effect of removing exclusive power from the commissioner and allowing the other transaction participants to have a voice in decisions.

In some embodiments, the transaction system selects the authorization system based on voting of the transaction participants. Just as later votes may follow the authorization method, when the league is set up, the transaction system may ask the transaction participants to decide on an authorization method to be used for ratifying decisions based on a majority vote or other default method.

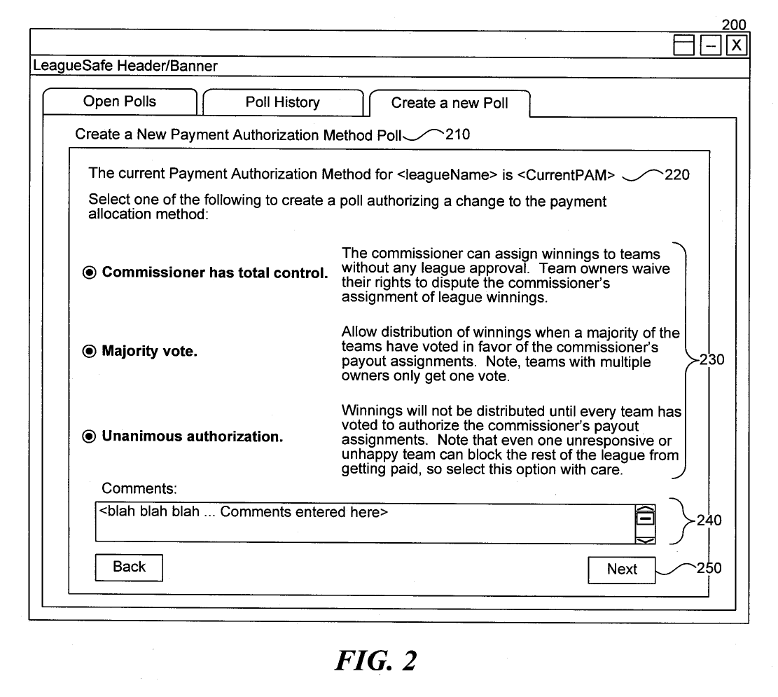

FIG. 2 is a display page that illustrates a user interface for the creation of a poll for selecting the authorization method in one embodiment. The display page 200 is typically displayed to the commissioner when setting up the league at the beginning of the season. The display page 200 contains a heading 210, descriptive information 220, a list of possible authorization methods 230, a comments area 240, and a submit button 250. The heading 210 describes the purpose of the display page 200. The descriptive information 220 provides any explanatory text, including a display of the current authorization method if one has been selected (or a default one exists). The list of possible authorization methods 230 displays the choices for the most popular types of authorization methods. Those of ordinary skill in the art will recognize that many other types of authorization methods could be displayed. The comments area 240 allows the poll creator to enter any comments for display to the voters. For example, the poll creator may refer to an earlier discussion about changing the authorization method that took place or problems encountered with the current authorization method to remind the voters of the reason for the poll. The submit button 250 submits the poll to the voters for ratification. For example, the transaction system may send an email to each voter (e.g., team owner) for entry of a vote to the poll.

In some embodiments, the transaction system invokes the authorization method for many different types of decisions. For example, the transaction system may invoke the authorization method anytime a payment is proposed to one of the transaction participants. The transaction system may also invoke the authorization method for non-payment decisions, such as a user-defined poll.

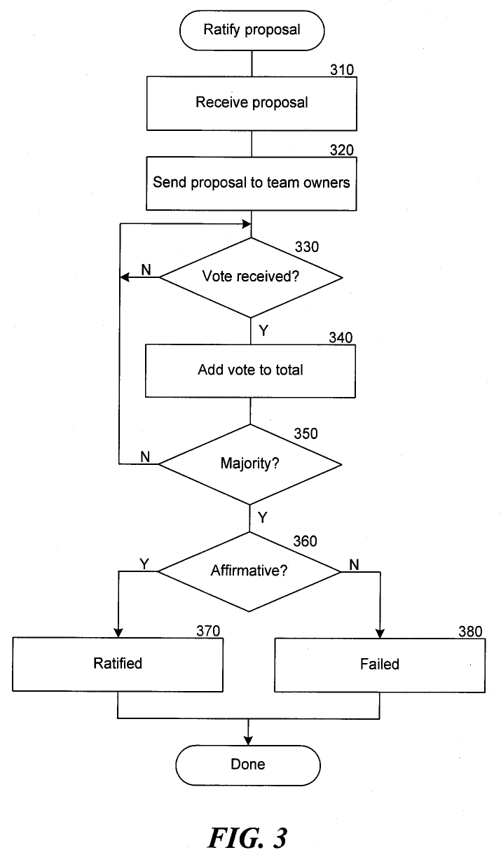

FIG. 3 is a flow diagram that illustrates the processing of the authorization method component to ratify a proposal using a majority authorization method in one embodiment. In block 310, the component receives a proposal from the commissioner for ratification by the team owners. In block 320, the component sends a communication to each of the team owners requesting that they vote on the proposal. In some embodiments (not shown), the component may receive comments or questions from team owners and distribute the comments to each of the other transaction participants. As a result, the commissioner may modify the proposal or send clarification. In decision block 330, the component waits to receive votes from the team owners. If the component receives a vote, then the component continues at block 340, else the component loops to block 330 to continue waiting for votes. In block 340, the component receives a vote from a team owner and adds the vote to the current total. In decision block 350, if the vote causes the total votes to be a majority, then the component continues at block 360, else the component loops to block 330 and waits to receive more votes. In decision block 360, if the majority constitutes an affirmative vote, then the component continues at block 370, else the component continues at block 380. In block 370, the component reports that the decision is ratified and then completes. In block 380, the component reports that the decision failed to be ratified and then completes.

A decision may also have an expiration date specified when the proposal is originally submitted. For example, the commissioner may submit a proposal at the beginning of the season that requests approval of a selected authorization method within 30 days. If the vote fails to pass within 30 days, then the transaction system may report that the vote failed. When a vote fails, the transaction system may automatically take action. For example, the transaction system may refund any payments by the transaction participants or may contact the commissioner to request that the commissioner select a course of action.

Following the ratification of a proposal, the transaction system may carry out any action specified by the proposal. For example, if the proposal requested approval for making a payment to one or more team owners, then the transaction system may automatically authorize the payment (e.g., by transferring an assets from the league balance to the team owner's balance) specified by the proposal. Thus, payments or other decisions can take place even if the commissioner is unavailable.

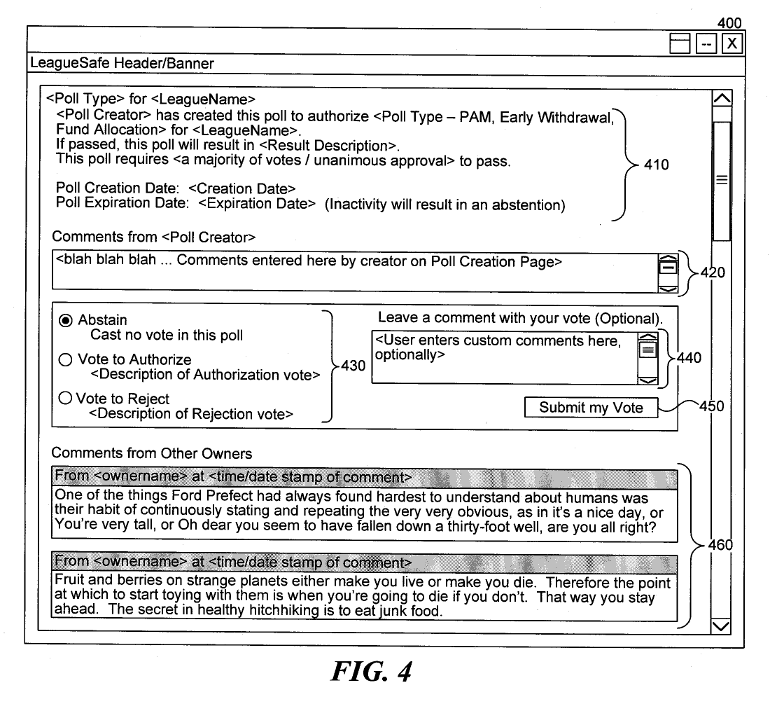

FIG. 4 is a display page that illustrates a user interface displayed by the user interface component for receiving votes in one embodiment. A team owner may receive an email with a link to a page such as the one shown when the commissioner submits a proposal or may navigate to the page from the team home page. The display page 400 contains a poll description area 410, a creator comments area 420, a vote selection area 430, a voter comments area 440, a submit button 450, and a previous comments area 460. The poll description area 410 contains descriptive information about the poll, such as the poll's purpose, the result if the poll passes, the votes required for the poll to pass, any expiration date for the poll, and so forth. The creator comments area 420 contains comments from the poll's creator (e.g., the commissioner or a team owner) that further describe the poll. The vote selection area 430 contains three vote choices that the voter can select: abstain, authorize, and reject. The voter comments area 440 receives any comments from the voter about the vote. The submit button 450 submits the voter's vote and comments to the transaction system. The previous comments area 460 displays the comments submitted by previous voters.

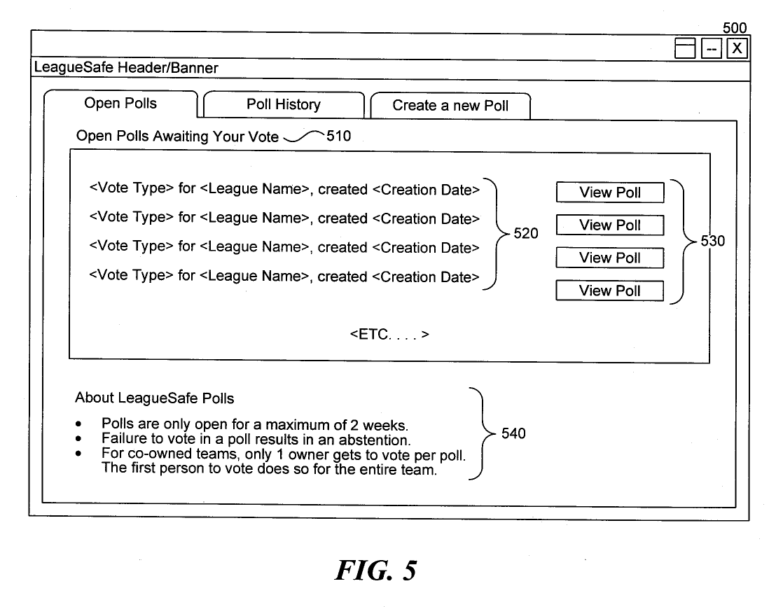

FIG. 5 is a display page that illustrates a user interface displayed by the user interface component for displaying a summary of polls in one embodiment. The component may display the page to a team owner or commissioner to enable him to view each of the polls awaiting his vote. The display page 500 contains a heading 510, a list of polls 520, a details button 530 for each poll, and a help text area 540. The heading 510 describes the purpose of the page. The list of polls 520 lists each outstanding poll, with some information about the poll, such as the type of vote and league to which the poll applies. The details button 530 for each poll allows the viewer of the page to view detailed information about the poll, such as that displayed in FIG. 4. The help text area 540 displays additional helpful information about polls.

### Reminders

In some embodiments, the transaction system automatically sends reminders to transaction participants (e.g., commissioners and team owners) until a particular transaction is completed. For example, at the beginning of the season the system may send reminders to team owners until the team owners pay their entry fee. This relieves the commissioner from the often tiresome task of tracking down team owners that have not paid and sending them requests to pay. The system may also notify the commissioner and team owners if the particular transaction is not completed within a specified period. For example, team owners may view every other owner's payment status on a team web page.

### Payments

In some embodiments, the transaction system may accept partial payments or overpayments from transaction participants. For example, during the beginning of the season, a player may make several partial payments until reaching the league entry fee. As another example, the transaction system may allow transaction participants to put a larger amount than they currently owe on deposit with the system and draw from it as payments become due.

### League Balance

In some embodiments, the transaction system tracks a balance for each league. The league balance may be displayed on a league home page provided by the transaction system and associated with the league. The commissioner can view the league balance and take action to contact team owners that have not paid or to pay out any payment that is due. The transaction system may also provide a historical log of deposits and withdrawals from the league balance that the commissioner and team owners can view.

The transaction system may also track a balance for each team owner. The team owner's balance may be displayed on a team owner's home page provided by the transaction system and associated with the team owner. As with the league balance, the transaction system may maintain a separate account for each team owner or may maintain fewer accounts and track the balance of each team owner with assets in the account or accounts. When a team owner provides funds to the system, the team owner may do so by first depositing the funds in the team owner's account and then transferring the funds from the team owner's account to the league account or the funds may go straight to the league account. Similarly, when a team owner is due funds, the league may pay the team owner by transferring funds from the league account to the team owner's account, and then the team owner may make a withdrawal (e.g., by ACH transfer, mailing a check, and so on).

In some embodiments, as a part of the authorization of payments at the end of the season, the commissioner reconciles any fees and prizes won during the season. For example, many leagues charge transaction fees to owners who make trades or alter their roster during the season. As another example, a team owner may have won a prize during the season for the performance of his/her team. These fees and prizes are accumulated over the course of the season, and reconciled at the end of the season by the commissioner. The commissioner may withdraw fees from any prize due to a particular team owner or from advance payments made at the beginning of the season before transferring funds from the league account to the team owner's account.

### Withdrawal of Funds

In some embodiments, the transaction system provides several ways for a team owner to withdraw assets from the transaction system. For example, the team owner may request that the transaction system send a paper check, make a bank (e.g., ACH) transfer, send a prepaid credit card, and so forth. The transaction system may charge a fee for some types of withdrawals. For example, the paper check and bank transfer may have an associated fee, whereas the prepaid credit card may not. If the team owner selects a prepaid credit card, the transaction system may allow the team owner to customize the card, such as by adding a team logo to the card, adding a message, and so on.

The transaction system may also allow assets to be withdrawn through a purchase of merchandise or services. For example, the transaction system may allow the team owner to purchase a t-shirt. The transaction system may also allow the team owner to convert the assets to points that can be used with other systems to obtain goods and/or services, such as airline, hotel, or dining points. The transaction system can provide these and many other ways of withdrawing assets.

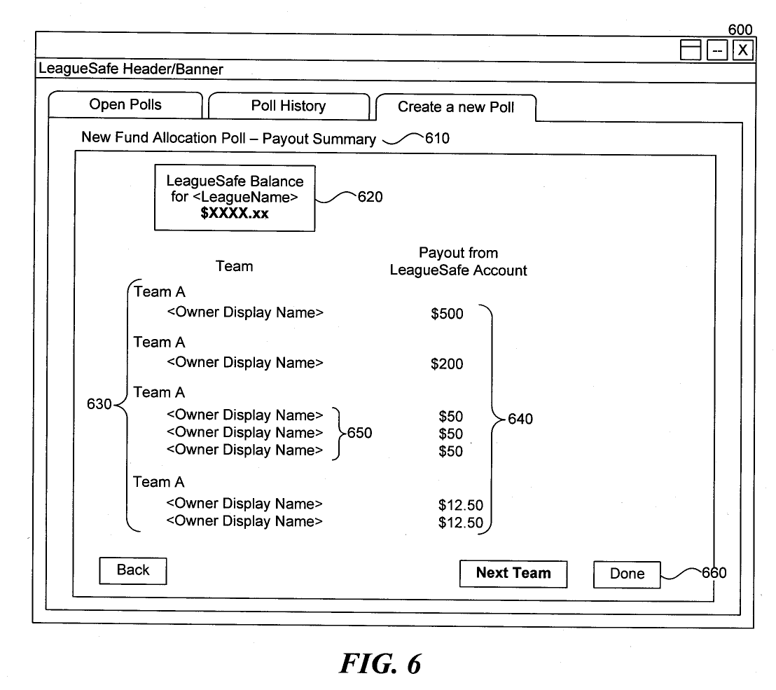

FIG. 6 is a display page that illustrates the creation of a poll for the final payout of the season in one embodiment. The display page 600 is typically displayed to the commissioner at the end of the season to designate a proposed payout of league assets. The display page 600 contains a heading 610, a league balance 620, a list of teams 630, a payout amount for each team owner 640, a list of owners of each team 650, and a submit button 660. The heading 610 describes the purpose of the display page. The league balance 620 displays the amount of assets associated with the league. For example, the assets may be a summary of each of the entry fees paid at the beginning of the season by the team owners. The list of teams 630 shows each of the teams that will divide the payout. For example, the first-place team may receive the highest amount, followed by payments for the second-, third-, and fourth-place teams. The nature of the payout may be agreed upon by the team owners through a poll at the beginning of the season. The payout amount for each team owner 640 shows how much of the league assets will be transferred to each team owner. The list of owners of each team 650 shows that each team may have multiple owners that divide the payout, as described in further detail herein. The submit button 660 submits the poll to the team owners for ratification.

### Owners

In some embodiments, the transaction system allows more than one person to co-own a team. The transaction system may allow each co-owner to access and modify information about the team. The first owner that makes a vote makes a binding vote for all of the co-owners. Alternatively, each owner may vote and the system may decide how to tally the votes.

In some embodiments, the transaction system receives payments from the commissioner on behalf of a team owner that cannot access the transaction system. For example, some team owners may not routinely use the Internet or may be uncomfortable with making online payments, but the commissioner and other team owners can still use the transaction system. The commissioner or other team owner can provide information and payments on behalf of the less savvy team owner.

### CONCLUSION

From the foregoing, it will be appreciated that specific embodiments of the transaction system have been described herein for purposes of illustration, but that various modifications may be made without deviating from the spirit and scope of the invention. For example, although fantasy sports have been used to describe the transaction system, the system can be used for managing decisions and payments in a variety of competitive environments. For example, the transaction system could be used for an AMERICAN IDOL league or tracking the results of other reality television shows, for tracking the performance of movies or stars, for office pools of many kinds, and so forth. The dispute resolution methods described can also be used outside of fantasy sports for automated resolution of many types of disputes. The transaction system can also be used in many environments where conditional payments are common. Accordingly, the invention is not limited except as by the appended claims.

I/We claim:

1. A method for providing a hosted service for managing league decisions and the collection and payment of money related to fantasy sports transactions, the method comprising:
receiving from a league commissioner league information describing a fantasy sports league, wherein the league information comprises at least an identification of one or more team owners that belong to the league, contact information of the one or more team owners, an entry fee for joining the league, and an authorization method that describes a process having one or more conditions for ratifying decisions related to the league;
automatically contacting the team owners using the contact information to invite the team owners to join the league and pay the entry fee;
receiving from at least one team owner team information and a payment of assets based on the entry fee, wherein the team information comprises at least an identification of one or more players that belong to the team;
storing assets from the payments of the team owners under the control of the hosted service so that the assets can only be accessed in accordance with the authorization method;
determining whether an event has occurred for which a payment of assets may be due;
when an event has occurred for which a payment of assets may be due, invoking the process described by the authorization method to determine whether the payment is due; and
when the conditions of the authorization method are satisfied, distributing the payment based on the authorization method from the assets stored under the control of the hosted service.

2. The method of claim 1, further comprising providing a user interface through which a team owner receives information about one or more pending league fees and can provide a payment of assets to satisfy the pending charges.

3. The method of claim 1 wherein assets comprise money paid through a credit card, bank transfer, or other payment of money.

4. The method of claim 1 wherein assets comprise points that are redeemable for merchandise or services.

5. The method of claim 1, further comprising securing access to the hosted service by requesting authentication information from users of the hosted service.

6. The method of claim 1 wherein the process specified by the authorization method comprises sending a request to each team owner that belongs to the league to vote on a payment and the conditions of the authorization method are satisfied upon receiving affirmative votes from a majority of team owners.

7. The method of claim 1, further comprising automatically contacting any team owners that have not provided team information after a predefined period.

8. The method of claim 1, further comprising, notifying the league of any team owner that has not paid the entry fee.

9. The method of claim 1 wherein determining whether an event has occurred for which a payment of assets may be due comprises receiving a notification that the event has occurred.

10. The method of claim 1 wherein determining whether an event has occurred for which a payment of assets may be due comprises automatically determining that the event has occurred based upon league rules.

11. The method of claim 1 wherein distributing the payment comprises issuing a prepaid credit card to a team owner.

12. The method of claim 1 wherein distributing the payment comprises sending an ACH transfer to a team owner's bank account.

13. The method of claim 1 wherein distributing the payment comprises allowing a recipient of the payment to customize the method of payment.

14. A computer-based system for managing decisions such as payments related to fantasy sports transactions, the system comprising:
a user interface component configured to display information to transaction participants, wherein the information includes a home page for each league and team, balance and transaction information about league and team accounts, and display pages for creating and viewing polls;
an authorization method component configured to store a currently selected authorization method and ensure that proposals are carried out in accordance with rules associated with the currently selected authorization method;
a poll management component configured to manage the creation of polls, receive votes from transaction participants, and tally the votes in accordance with the currently selected authorization method;
a communication component configured to send communications to transaction participants;
a payment component configured to process payments including deposits and withdrawals to and from league and user accounts; and
one or more information stores configured to store information about the leagues, teams, and assets managed by the system.

15. The system of claim 14 wherein the poll management component is further configured to send a reminder at a first specified time during the lifetime of a poll and terminate the poll if an insufficient number of votes are received to ratify the poll after a second specified time.

16. The system of claim 14 wherein the payment component further comprises a bank access component configured to access bank accounts and a credit card payment component configured to process credit card payments.

17. The system of claim 14, further comprising an import component configured to import external information to the transaction system, including league information and owner information from other systems.

18. The system of claim 14, further comprising an export component configured to export information from the transaction system, including providing an externally accessible application programming interface for accessing information stored by the transaction system through which transaction participants or third parties can extend the transaction system with additional functionality.

19. A computer-readable storage medium encoded with instructions for controlling a computer system to ratify a proposed decision within a fantasy sports league, by a method comprising:
receiving a request from a league commissioner to create a poll for voting on the proposed decision;
sending a request to each of multiple team owners in the league to vote on the proposed decision;
receiving a response from one or more of the team owners indicating their vote on the received poll; and
when a majority of affirmative votes are received from the team owners, ratifying the proposed decision.

20. The computer-readable medium of claim 19 further comprising, if a majority of affirmative votes are not received within a specified time, terminating the poll and indicating that the proposed decision is not ratified.
